(19) United States
(12) Patent Application Publication
(10) Pub. No.: US 2004/0055268 A1
(43) Pub. Date: Mar. 25, 2004

(54) Feeding device for a round bailer

(76) Inventor: Thomas Schuster, Kammlach (DE)

Correspondence Address: KNOBBE MARTENS OLSON & BEAR LLP, 2040 MAIN STREET, FOURTEENTH FLOOR, IRVINE, CA, 92614, US

(21) Appl. No.: 10/380,602

(22) PCT Filed: Sep. 14, 2001
(86) PCT No.: PCT/EP01/10625

(30) Foreign Application Priority Data
Sep. 14, 2000 (DE) 100458424

(51) Int. Cl. A01D 39/00

(52) U.S. Cl. 56/341

(57) ABSTRACT

The aim of the invention is to provide a simple, A variable design for a device for feeding webs of netting or film for wrapping bails (3), especially round bails, on their lateral surface in a round bailer. The netting/film web (2) is drawn off from a netting or film roll (5) through guiding rollers (4, 4′). To this end, the invention provides that at least one guiding roller (4), preferably both two guiding rollers (4, 4′), is/are knurled (7) in the axially central area.

### DESCRIPTION

A feeding device for a round bailer

The invention relates to a feeding device for webs of netting or film for wrapping bails, especially round bails, with the web of netting or film being drawn off from a netting or film roll by means of guide rollers.

Such a feeding device is known for example form DE 195 36 750 C2. In this case a web of netting is drawn off from a roll of netting by means of guide rollers in order to be introduced into a round bailer. Said web of netting is used for encasing the round bail in a form-fixing manner, especially a bail of waste. This feeding device which is generally known is hardly suitable for rolls of film because they are generally based on a relatively adhesive stretch film. The use of a web of film for wrapping a round bail on its jacket surface in a round bailer would be desirable because such stretch adhesive films are often also used in a downstream film winder. As a result, the use of a web of film would be desirable when necessary as an alternative to a web of netting within the terms of a simpler procurement of consumables. In particular, a web of film is to be pre-tensioned during the drawing off up to a certain degree and a secure feeding of the web of film is to be achieved, optionally in a gathered state at the beginning of the winding.

The invention is thus based on the object of providing a feeding device for webs of film or netting which is configured in a simple manner and allows a secure supply of the web of netting or film. In particular, the use of a web of film in a gathered state is to be enabled.

This object is achieved by a feeding device according to the features of claim 1. Advantageous embodiments are the subject matter of the sub-claims.

By providing knurls on at least one guide roller, preferably on two mutually opposite guide rollers, the web of netting or film to be introduced into the bailer is grasped securely. This allows, on the one hand, a reliable feed of a gathered web of film at the beginning of the winding. On the other hand, the knurling allows a high braking force, so that especially when films are used guide rollers will not stick together or film will not wrap around the rollers. The gathered, actually very sticky stretch plastic film is slightly perforated by the knurling, which is preferably provided on both sides, so that an a result of the low surface especially in the form of edges or tips a sticking together is reliably prevented. As a result of this slight perforation, a secure traction is also achieved.

In a preferred embodiment the guide rollers are provided with a crowned arrangement, so that the deflection by said bowing is compensated. The guide roller, and especially the drive roller and/or the press roller, is preferably provided with a rubber coating. The knurling, especially in the form of two screwed-on sunk knurled cups. Is provided in the axial middle part. In this way, the guide roller, which is used for insertion into the bailer when the top end of the film is inserted, can be used as a braking roller during th further winding process. In this way the plastic film is stretched to the desired extent in order to keep the consumption of film as low as possible.

An embodiment of the feeding device is explained and described below in closer detail by refer nce to the enclosed drawing, wherein:

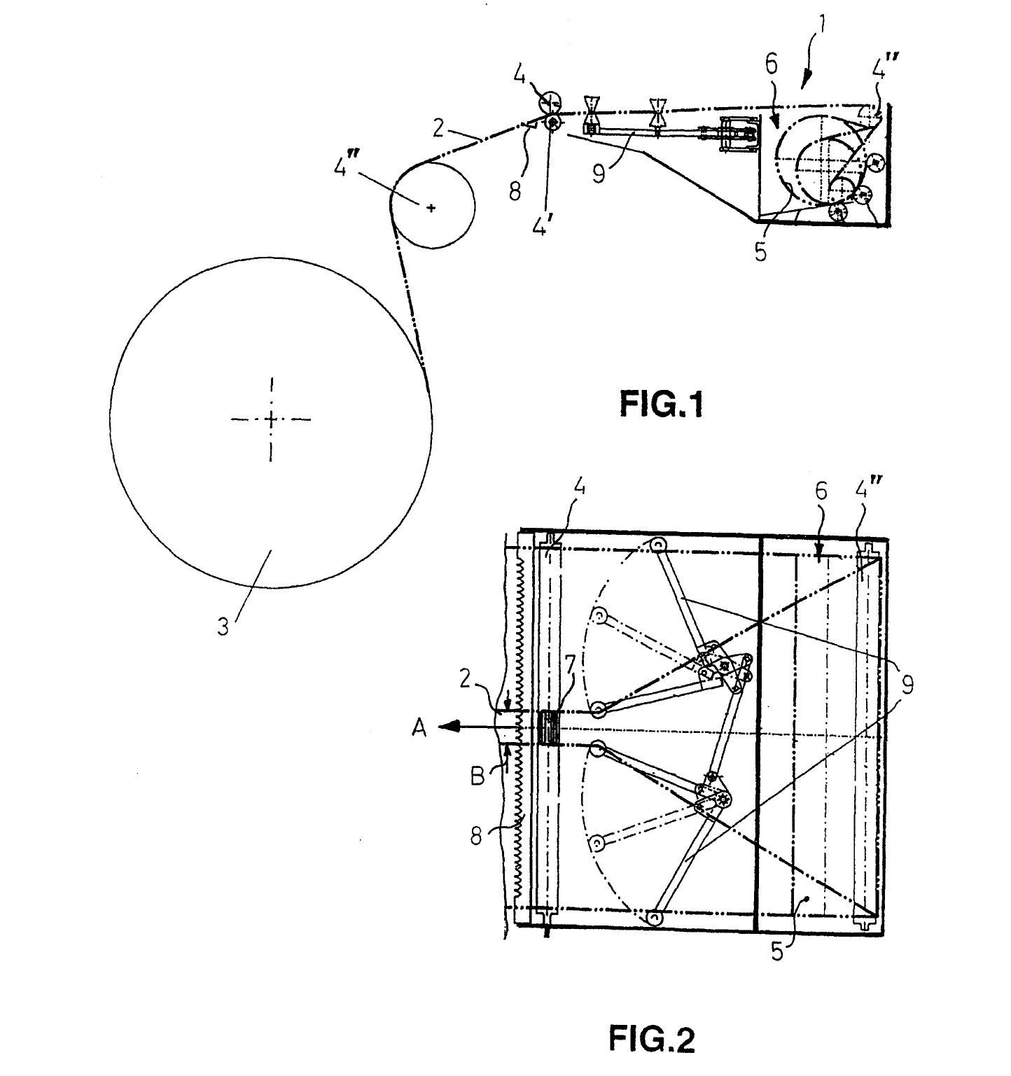

FIG. 1 shows a side view of a feeding device in a round bailer;

FIG. 2 shows a top view according to FIG. 1;

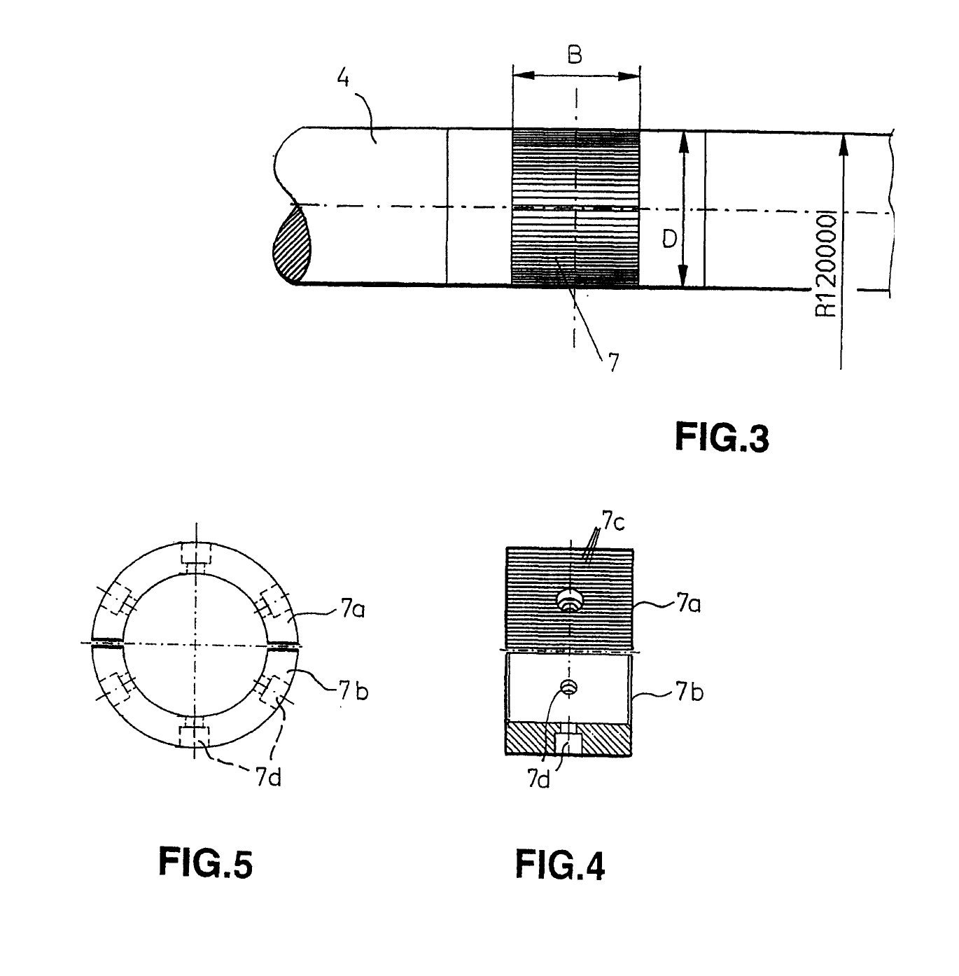

FIG. 3 shows an enlarged view of a guide roller;

FIG. 4 shows a detailed view according to FIG. 3, and

FIG. 5 shows a side view according to FIG. 4.

FIG. 1 shows a feeding device 1 for webs 2 of netting or film for wrapping bails 3, especially round bails, on its jacket surface in a round bailer not shown in closer detail. In this process, the web 2 of netting or film is drawn off from a roll 5 of netting or film by means of several guide rollers 4. The term guide roller 4 also comprises the deflection rollers 4″, which are arranged on the one hand close to the bail 3 or the round bailer and on other hand in the direct vicinity of the roll 5 of netting or film.

The netting or film roll 5 is arranged in a roll box 6 which is upwardly open, so that the netting or film web 2 is drawn off in a width of approx. 1 m towards the bail 3 after deflection at the allocated deflection roller 4′, As a result of this open configuration of the roll box 6, the insertion of the netting or film roll 5 is possible in a simple fashion. As a result of this draw-off direction according to arrow A, the film roll 5 moves on an inclined floor ramp, at a result of which the film web 2 is braked with a defined force in order to obtain the desired light pre-tension.

FIG. 2 further shows a gatherer 9 which is used at the beginning of the winding to gather the film web 2 which has a width of approx. 1 m to a substantially smaller width B. In this way the film is gathered into a “plait”, as a result of which the same is inherently stable to such an extent that said “plait” can be inserted into the bailer. Furthermore, FIG. 2 shows the application of a knurling 7 on at least one guide roller 4. Preferably, said guide roller 4 is used as a drive roller at the beginning of the winding and as a braking roller in the further winding process. A press roller 4′ is provided below said guide roller 4 (cf. FIG. 1), which press roller can also be provided with such a knurling 7 in the central region. As a result of said knurling(s) 7 in the central region of the guide roller(s) 4, a secure feed of the film web 2 is achieved and the adherence of the film to the rollers is prevented. Notice must be taken that the gatherer 9 is only used at the beginning of the winding in order to achieve the narrow width B, whereas after the introduction of the “film plait” the gatherer 9 will pivot back to its initial width, so that the film web 2 is supplied to the bailer with its entire width.

In FIG. 3 the central region of guide roller 4 is shown with the knurling 7. Said knurling 7 assumes the approximate Width B of the gathered film plait. In the middle of the guide roller 4 it shows the largest diameter D (e.g. 59 mm), whereas the diameter is merely 58 mm at the outer ends of the guide roller 4.

In this way a crowned or mbossed shape of the guide roller 4 is achieved, as is also shown by the indication of the radius arrow. The deflection of the relatively slend r guide rollers 4 or 4′ is compensated, so that en even contact of th netting or film web 2 is achieved.

FIG. 4 shows a preferred embodiment of the knurling 7 in the form of two knurl cups 7a and 7b in a semi-sectional view. The knurling 7 is achieved in this case by slightly rounded edges 7c (or by tips in the case of axial and circumferential knurlings) which achieve a minimal clawing or perforation of the passing film web 2. The adherence of the film to the rollers is thus prevented. The knurl cups 7a, 7b are arranged in a sunk fashion by bores 7d (also see FIG. 5) in the central region of the guide roller 4, thus producing an approximately flush transition relative to the remaining surface of the guide roller 4. FIG. 5 shows a side view according to FIG. 4. A halved partition of the knurl cups 7a and 7b is shown. It is obvious that any other partition (e.g. with three or four knurl cups) can be chosen.

After the conveyance of the netting or film web 2 with sufficient windings around the bail 3, the gatherer 9 moves together again and forms the film plait. By pivoting back the deflection roller 4″ close to the bail the film plait is cut off over the jagged knife 8, so that the bail 3 can be removed from the bailer. For a “new” bail 3 to be wound, the drive of the guide roller 4 is activated, as a result of which the gathered plait of the film web 2 is pushed into the press. Thereupon the gatherer 9 opens and the film 2 unfolds to the width of the roll. The netting or film web 2 is accelerated by being grasped in the bailer, so that the drive is changed over on at least one of the guide rollers 4 to braking operation, e.g. via a hydraulic brake. In cooperation with the rubber-coated guide roller 4 and the slightly embossed surface of the other guide roller 4′ one thus obtains and even and secure wrapping of the bail 3.

1. A feeding device for netting or film webs for wrapping bails (3), especially round bails, on their jacket surface in a round bailer, with the netting or film web (2) being drawn off by means of guide rollers (4, 4′) from a netting or film roll (5), characterized in that at least one guide roller (4) comprises a knurlng (7) in the axially central region.

2. A feeding device as claimed in claim 1, characterized In that the knurling (7) is formed by several, especially two, knurl cups (7a, 7b).

3. A feeding device as claimed in claim 1 or 2, characterized in that a guide roller (4) is arranged as a drive roller and a press roller (4′) Is arranged opposite of the same, with both thereof being provided with opposite knurlings (7).

4. A feeding device as claimed in one of the claims 1 to 3, characterized in that at least one of the guide rollers (4) is provided with a crowned shape in the axial direction.

5. A feeding device as claimed in one of the claims 1 to 4, characterized in that at least one of the guide rollers (4) can be braked electrically or hydraulically in order to increase the pretension of the netting or film.

6. A feeding device as claimed in one of the claims 1 to 5, characterized in that for introducing the noting or film web (2), a gatherer (9) for constricting the direction of the width, especially to the axial width (B) of the knurling (7), is provided.

7. A feeding device as claimed in claim 6, characterized in that the knurling (7) for perforating the film web (2) comprises closely adjacent, rounded edges (7c) in the gathered state.

8. A feeding device as claimed in claim 7, characterized in that a jagged knife (S) for cutting the netting/film web (2) is arranged adjacent to the press roller (4′).

9. A feeding device as claimed in one of the claims 1 to 8, characterized in that at least one guide roller (4) comprises a rubber-coated surface.
